(19) United States
(12) Patent Application Publication
(10) Pub. No.: US 2017/0011479 A1
(43) Pub. Date: Jan. 12, 2017

(54) DOCUMENT ANALYSIS SYSTEM, DOCUMENT ANALYSIS METHOD, AND DOCUMENT ANALYSIS PROGRAM

(71) Applicant: UBIC, INC., Tokyo (JP)

(72) Inventors: Masahiro MORIMOTO, Tokyo (JP); Yoshikatsu SHIRAI, Tokyo (JP); Hideki TAKEDA, Tokyo (JP); Kazumi HASUKO, Tokyo (JP); Akiteru HANATANI, Tokyo (JP)

(21) Appl. No.: 15/116,207

(22) PCT Filed: Feb. 4, 2014
(86) PCT No.: PCT/JP2014/052578

§ 371 Date: Aug. 2, 2016

(51) Int. Cl. G06Q 50/18; G06F 17/30

(52) U.S. Cl. CPC G06Q 50/18; G06F 17/3071; G06F 17/30675; G06F 17/30011

(57) ABSTRACT

Possible events in the future can be predicted by analyzing existing data. A document analysis system (1) includes: a score calculator (116) that calculates a score that represents a strength of connection of a document extracted from document information to a classification symbol representing a degree of relevancy between the document information and a litigation or fraud investigation; a phase identifying section (122) that identifies a phase by which a predetermined action to be a cause of the litigation or fraud investigation is classified along with development of the predetermined action, based on the calculated score; and a change estimation unit (120) that estimates change in the identified phase, based on temporal transition of the phase.

### TECHNICAL FIELD

The present invention relates to a document analysis system and the like that analyze document information recorded in a predetermined computer or server.

### BACKGROUND ART

The background art of the present invention is described for a case where a litigation case or fraud investigation is adopted as an investigation case, for example. Conventionally, for the cases of occurrence of a crime or a legal dispute related to computers, such as an unauthorized access and classified information leakage, equipment required to find the cause of the crime and dispute and required for investigation, and means and technologies for collecting and analyzing data and electronic records and clarifying their legal admissibility and competence of evidence have been proposed.

Particularly, civil litigation in the United States requires eDiscovery (electronic discovery) and the like. All the plaintiffs and defendants of the litigation are responsible for submitting related digital information as evidence. Consequently, digital information stored in computers and servers is required to be submitted as evidence.

According to rapid development and proliferation of IT, most of information has been created by computers in today's business. Thus, even an identical company is inundated with much digital information.

Consequently, in a process of performing preparation work for submitting evidentiary materials to a court, even errors of including classified digital information that is not necessarily related to the litigation tend to occur. Furthermore, submission of classified document information unrelated to the litigation is a problem.

In recent years, techniques pertaining to document information in forensic systems have been proposed in the following Patent Literatures 1 to 3. However, for example, the forensic systems such as those of Patent Literatures 1 to 3 collect enormous amounts of document information on users having used multiple computers and servers.

Work of classifying whether such enormous amounts of digitized document information is appropriate as evidentiary materials for a litigation or not requires a user called a reviewer to visually verify and classify the document information on a piece-by-piece basis, which causes a problem of causing enormous efforts and costs.

A document classification system for solving the above problems is proposed in Patent Literature 4. Patent Literature 4 discloses a document classification system that obtains digital information recorded in multiple computers or servers, analyzes document information included in the obtained digital information, and classifies the information so as to facilitate use for a litigation, including: an extractor that extracts a document group that is a data set including a predetermined number of documents from the document information; a document display unit that displays the extracted document group on a screen; a classification symbol acceptor that accepts a classification symbol assigned to the displayed document group by a user based on relevance to the litigation; a selector that classifies the extracted document group with respect to each classification symbol, based on the classification symbol, and analyzes and selects a keyword commonly appearing in the classified document group; a database that records the selected keyword; a searcher that searches the document information for the keyword recorded in the database; a score calculator that calculates a score representing relevance between the classification symbol and the document using a search result of the searcher and an analysis result of the selector; and an automatic classifier that automatically assigns the classification symbol, based on a result of the score.

Patent Literature 5 discloses a time-series prediction apparatus including: characteristics obtaining means for obtaining the characteristics of time series from previous time-series data; creation means for creating a regression tree, based on the amount of characteristics obtained by the characteristics obtaining means; current time series characteristics obtaining means for obtaining the amount of characteristics from current time-series data using the same algorithm as that of the characteristics obtaining means; and prediction means for obtaining a predictive value in the future using the amount of characteristics obtained by the current time series characteristics obtaining means and the regression tree created by the creation means.

### CITATION LIST

### Patent Literature

Patent Literature 1: Japanese Patent Application Laid-Open No. 2011-209930
Patent Literature 2: Japanese Patent Application Laid-Open No. 2011-209931
Patent Literature 3: Japanese Patent Application Laid-Open No. 2012-32859
Patent Literature 4: Japanese Patent Application Laid-Open No. 2013-182338
Patent Literature 5: Japanese Patent Application Laid-Open No. 2001-175735

### SUMMARY OF INVENTION

### Technical Problem

The document classification system disclosed in Patent Literature 4 analyzes previous events at a stage of institution of a lawsuit. Consequently, preventive measures through prediction of possible events in the future cannot be taken; for example, measures of preventing development to a litigation cannot be taken. The time-series prediction apparatus as in Patent Literature 5 does not have an object to facilitate analysis of document information used for a litigation.

The present invention has been made in view of the above problem, and has an object to provide a document analysis system, a document analysis method and a document analysis program that predict possible events in the future by analyzing existing data.

### Solution to Problem

To solve the problem, a document analysis system of the present invention is a document analysis system that obtains information recorded in a predetermined computer or server, and analyzes document information including multiple documents included in the obtained information, including: a score calculator that calculates a score that represents a strength of connection of a document extracted from the document information to a classification symbol representing a degree of relevancy between the document information and a litigation or fraud investigation; a phase identifying section that identifies a phase by which a predetermined action to be a cause of the litigation or fraud investigation is classified along with development of the predetermined action, based on the score calculated by the score calculator; and a change estimation unit that estimates change in the phase identified by the phase identifying section, based on temporal transition of the phase.

The document analysis system may further include a score moving average calculator that calculates a moving average of the scores calculated by the score calculator, wherein the change estimation unit estimates change in the phase by calculating a correlation between the moving average calculated by the score moving average calculator and a predetermined pattern.

The document analysis system may further include a presentation unit that presents the change in the phase estimated by the change estimation unit in a manner allowing a user to grasp the change.

The document analysis system may further include a classification symbol assigner that assigns the classification symbol to each of the documents using a keyword and/or text included in the text information.

To solve the problem, a document analysis method of the present invention is a document analysis method that obtains information recorded in a predetermined computer or server, and analyzes document information including multiple documents included in the obtained information, including: a score calculation step of calculating a score that represents a strength of connection of a document extracted from the document information to a classification symbol representing a degree of relevancy between the document information and a litigation or fraud investigation; a phase identification step of identifying a phase by which a predetermined action to be a cause of the litigation or fraud investigation is classified along with development of the predetermined action, based on the score calculated in the score calculation step; and a change estimation step of estimating change in the phase identified in the phase identification step, based on temporal transition of the phase.

To solve the problem, a document analysis program of the present invention is a document analysis program that obtains information recorded in a predetermined computer or server, and analyzes document information including multiple documents included in the obtained information, causing a computer to achieve: a score calculation function of calculating a score that represents a strength of connection of a document extracted from the document information to a classification symbol representing a degree of relevancy between the document information and a litigation or fraud investigation; a phase identifying function of identifying a phase by which a predetermined action to be a cause of the litigation or fraud investigation is classified along with development of the predetermined action, based on the score calculated by the score calculation function; and a change estimation function of estimating change in the phase identified by the phase identifying function, based on temporal transition of the phase.

### Advantageous Effects of Invention

The document analysis system, the document analysis method and the document analysis program of the present invention can predict possible events in the future by analyzing existing data. Consequently, the document analysis system and the like can take measures that prevent unfavorable situations, such as development to a litigation, for example.

### BRIEF DESCRIPTION OF DRAWINGS

FIG. 1 is a block diagram showing a configuration example of a document analysis system according to an embodiment of the present invention.

FIG. 2 is a graph schematically showing estimation (prediction) executed by a change estimation unit.

FIG. 3 is a schematic diagram showing an example of situations of phase change presented by the presentation unit.

FIG. 4 is a flowchart showing an example of processes executed by the document analysis system.

FIG. 5 is a table showing the attributes of document case 1 and case 2 that are investigation targets in a document analysis method according to the present invention.

FIG. 6 is a graph showing the relationship between the score and transmission date in the document analysis method.

FIG. 7 is a graph showing the relationship between the moving average of scores and transmission date in the document analysis method.

FIG. 8 is a graph showing the relationship between the difference moving average of scores and transmission date in the document analysis method.

FIG. 9 is a table showing the relationship between the difference of score moving averages (DMA), transmission date, main (rising) edge, and “IN”.

FIG. 10 is a chart showing a flow of processes on a stage-by-stage basis according to the embodiment.

FIG. 11 is a chart showing a processing flow of a keyword database according to the embodiment.

FIG. 12 is a chart showing a processing flow of a related term database according to this embodiment.

FIG. 13 is a chart showing a processing flow of a first automatic classifier according to this embodiment.

FIG. 14 is a chart showing a processing flow of a second automatic classifier according to this embodiment.

FIG. 15 is a chart showing a processing flow of a classification symbol accepting and assigning unit according to this embodiment.

FIG. 16 is a chart showing a processing flow of a classification symbol assigning document analyzer according to this embodiment.

FIG. 17 is a graph showing an analysis result in the document analyzer according to this embodiment.

FIG. 18 is a chart showing a processing flow of a third automatic classifier according to one example of this embodiment.

FIG. 19 is a chart showing a processing flow of a third automatic classifier according to another example of this embodiment.

FIG. 20 is a chart showing a processing flow of a quality inspector according to this embodiment.

FIG. 21 shows a document display screen according to this embodiment.

### DESCRIPTION OF EMBODIMENTS

### Configuration of Document Analysis System 1

The document analysis system 1 according to the embodiment of the present invention is a system that obtains a large amount of digital information (big data) recorded in multiple computers and servers, and analyzes document information including multiple documents included in the obtained digital information. Here, for example, a litigation, fraud investigation, financial event, meteorological event, or cases related to diagnosis and treatment is selected as an investigation case.

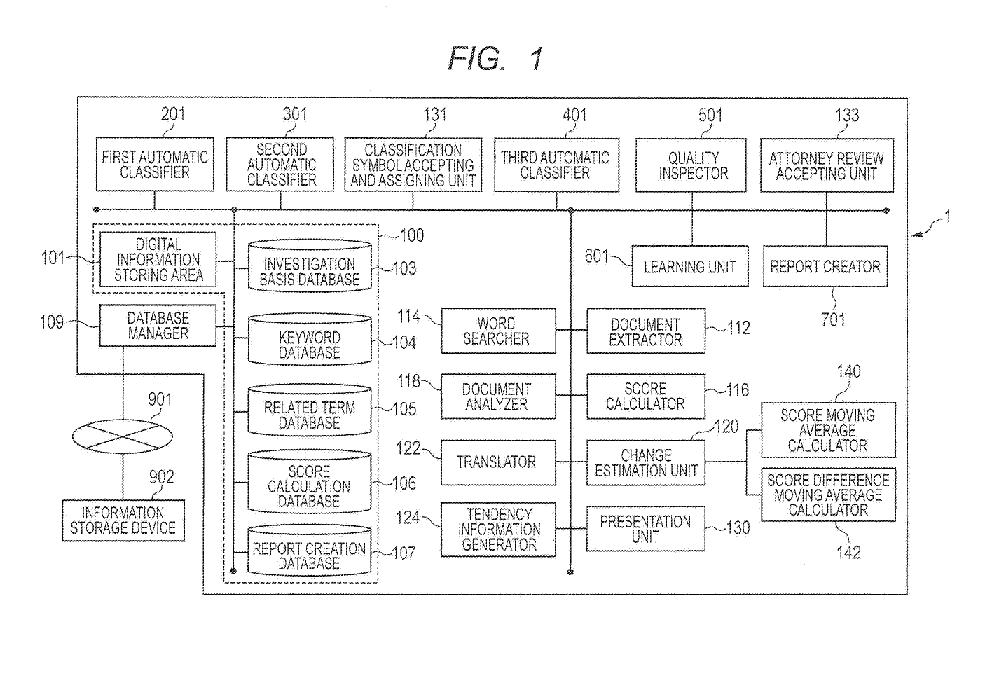

FIG. 1 is a block diagram showing a configuration example of a document analysis system 1. As shown in FIG. 1, the document analysis system 1 includes a data storage 100 (a digital information storing area 101, an investigation basis database 103, a keyword database 104, a related term database 105, a score calculation database 106, and a report creation database 107), a database manager 109, a document extractor 112, a word searcher 114, a score calculator 116, a phase identifying section 122, a change estimation unit 120, a score moving average calculator 140, a score difference moving average calculator 142, a first automatic classifier 201, a second automatic classifier 301, a presentation unit 130, a classification symbol accepting and assigning unit 131, a document analyzer 118, and a third automatic classifier 401. The document analysis system 1 may further include a tendency information generator 124, a quality inspector 501, a learning unit 601, a report creator 701, an attorney review accepting unit 133, a language determiner (not shown), a translator (not shown), a score change detector (not shown), and a score change determiner (not shown).

### (Data Storage 100)

The data storage 100 stores, in a digital information storing area 101, digital information obtained from multiple computers or servers for use for analyzing a litigation or fraud investigation. The data storage 100 includes an investigation basis database 103, a keyword database 104, a related term database 105, a score calculation database 106, and a report creation database 107. As described in FIG. 1, the data storage 100 may be a recording medium included in the document analysis system 1, or an external recording medium connected in a manner capable of communication to the document analysis system 1.

The investigation basis database 103 holds a category attribute that indicates which category the case falls into among, for example, litigation cases including antitrust, patent, The Foreign Corrupt Practices Act (FCPA), Products Liability (PL), and/or fraud investigation including information leakage and billing fraud, a company name, a person in charge, a custodian, and the configuration of an investigation or classification input screen.

The keyword database 104 holds a specific classification symbol of a document, a keyword having a close relationship with the specific classification symbol, and keyword correspondence information representing the correspondence relationship between the specific classification symbol and the keyword, which are included in the obtained digital information.

The related term database 105 holds a predetermined classification symbol, a related term including a word having a high appearance frequency in a document assigned the predetermined classification symbol, and related term correspondence information representing the correspondence relationship between the predetermined classification symbol and the related term.

The score calculation database 106 holds a weight for a word included in the document in order to calculate a score that represents the strength of connection between the document and the classification symbol.

The report creation database 107 stores the category, the custodian, and the form of a report defined according to the content of classification work.

### (Database Manager 109)

The database manager 109 manages update of the content of data in an investigation basis database 103, a keyword database 104, a related term database 105, a score calculation database 106, and a report creation database 107. The database manager 109 may be connected to an information storage apparatus 902 via a dedicated connection line or an Internet line 901. In this case, the database manager 109 may update the content of data in the investigation basis database 103, the keyword database 104, the related term database 105, the score calculation database 106, and the report creation database 107, on the basis of the content of data stored in the information storage apparatus 902.

### (Document Extractor 112)

The document extractor 112 extracts multiple documents from the document information.

### (Word Searcher 114)

The word searcher 114 searches the document information for the keyword or related term recorded in the database.

### (Score Calculator 116)

The score calculator 116 calculates a score that represents the strength of connection of the document extracted from the document information to the classification symbol representing the degree of relevancy between the document information and the litigation or fraud investigation. The score calculator 116 may calculates the score in a time series manner. The score calculator 116 may calculate the score of a predetermined action that is a cause of the litigation or fraud investigation, on a phase-by-phase basis for classification, according to advancement of the action. A method of calculating the score is described later in detail.

### (Phase Identifying Section 122)

The phase identifying section 122 identifies the phase by which the predetermined action to be a cause of the litigation or fraud investigation is classified along with the development of the predetermined action, according to the score calculated by the score calculator 116.

Here, the predetermined action may be, for example, an action related to a fraud action, such as antitrust, patent, The Foreign Corrupt Practices Act, product liability, information leakage, or billing fraud (e.g., attendance to a price adjustment meeting with competitors). The phase is an indicator representing each stage of development of the predetermined action. For example, the phase of “relationship building” is a stage that serves as a precondition of the phase of competition, and is a stage of constructing a relationship with customers and competitors. The phase of “preparation” is a stage of exchange of information related to competition with a competitor (that may be a third party). The phase of “competition” is a stage where a price is presented to a customer, feedback is obtained, and communication is achieved with the competitor about the feedback. For example, a predetermined action of “inquiry from a customer” belongs to a phase of “relationship building”. A predetermined action of “obtainment of production situations of the competitor” belongs to a phase of “preparation”.

The phase identifying section 122 identifies “which phase the current state is” on the basis of the score calculated by the score calculator 116. More specifically, the scores corresponding to the respective phases are calculated by the score calculator 116, the phase identifying section 122 identifies the phase (e.g., the phase where the score has the maximum value) according to a result of comparison of the scores.

Alternatively, the ranges of the values of scores may be assigned the respective phases. The phase identifying section 122 may identify the phase corresponding to the score. Alternatively, the phase identifying section 122 may identify the phase (maximum likelihood phase) where a predetermined action subject (an organization made up of one or more individuals) maximizes the likelihood (a value calculated as the score according to each phase) of a model (the observation process, likelihood function) representing a process reaching the predetermined action.

### (Change Estimation Unit 120)

The change estimation unit 120 estimates change in phase identified by the phase identifying section 122 on the basis of temporal transition of the phase. More specifically, for example, when a series of transition where the phase “relationship building” transitions to the phase “preparation” and develops to the phase “competition” is evident (by holding time series information representing temporal order of phases) and the phase identifying section 122 identifies that the current phase is the phase of “preparation”, the change estimation unit 120 estimates that subsequent transition is development to the phase “competition”.

Alternatively, the change estimation unit 120 may estimate change in phase by calculating the correlation between the moving average calculated by the score moving average calculator 140 and a predetermined pattern. Here, the predetermined pattern may be a pattern where the score calculated in a litigation or fraud investigation other than the litigation or fraud investigation concerned changes according to lapse of time.

For example, in the case where analysis related to a previously instituted litigation has been performed in order to submit evidentiary materials in the litigation and the moving average of the score has been calculated, the change estimation unit 120 adopts the moving average as the predetermined pattern, and calculates the correlation between the moving average of score for the document information to be analyzed this time and the predetermined pattern. In other words, the change estimation unit 120 calculates the degree of coincidence (correlation) therebetween while shifting the elapsed time and/or score. When the correlation therebetween becomes high, the change estimation unit 120 estimates that the score at this time will have a similar value in conformity with the predetermined pattern in the future. Consequently, the phase identifying section 122 identifies the phase in the future on the basis of a possible score in the future.

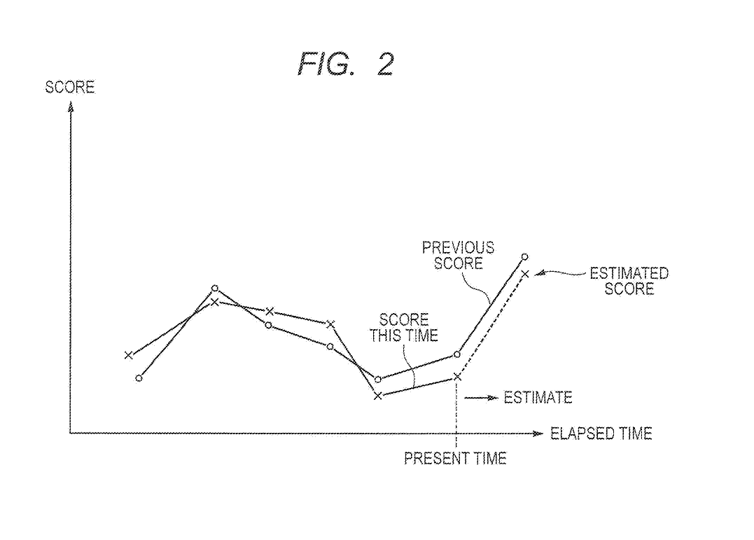

FIG. 2 is a graph schematically showing estimation (prediction) executed by the change estimation unit 120. The ordinate axis of the graph indicates the magnitude of the score, and the abscissa axis indicates the elapsed time. As shown in FIG. 2, when the degree of coincidence (correlation) between (the moving average of) the score calculated this time and (predetermined pattern, the moving average of) the score calculated previously is high, it can be considered that a score in the future that has not been calculated yet would have a high degree of coincidence. Consequently, the change estimation unit 120 estimates the score in the future in conformity with the previous score.

### (Score Moving Average Calculator 140)

The score moving average calculator 140 calculates the moving average of scores calculated by the score calculator 116.

### (Score Difference Moving Average Calculator 142)

The score difference moving average calculator 142 calculates the difference moving average of the scores from the short-term moving average and long-term moving average of the scores.

### (First Automatic Classifier 201)

When a keyword stored in the keyword database 104 is searched for by the word searcher 114 and a document including the keyword is extracted by the document extractor 112, the first automatic classifier 201 automatically assigns a specific classification symbol to the extracted document on the basis of the keyword correspondence information.

### (Second Automatic Classifier 301)

When the documents including the related terms stored in the related term database are extracted from the document information and the scores are calculated on the basis of the evaluated values of the related terms and the number of related terms included in the extracted document, the second automatic classifier 301 automatically assigns the predetermined classification symbol to the documents having a score exceeding a certain value among the documents including the related terms on the basis of the score and the related term correspondence information.

### (Presentation Unit 130)

The presentation unit 130 presents the change in phase estimated by the change estimation unit 120, in a manner allowing the user to grasp the change.

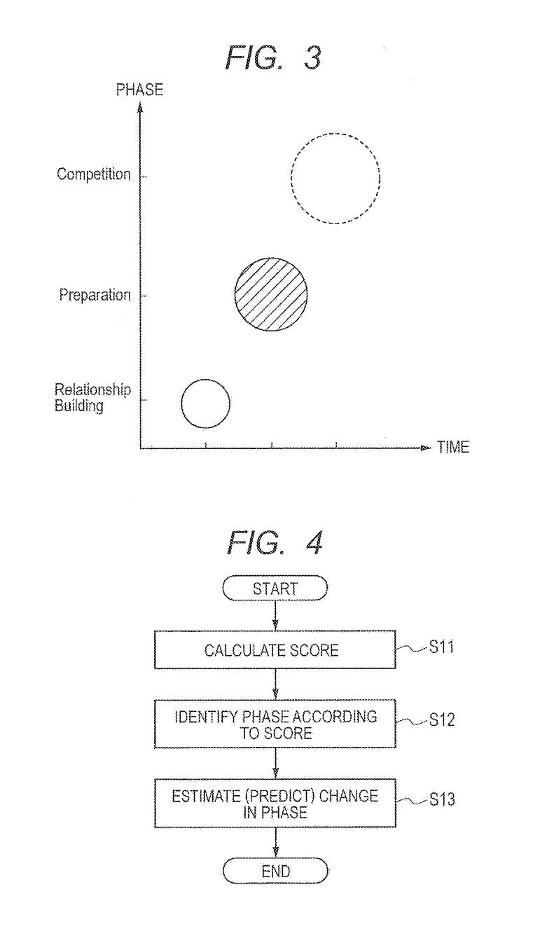

FIG. 3 is a schematic diagram showing an example of situations of phase change presented by the presentation unit 130. As shown in FIG. 3, the situations where the current phase identified by the phase identifying section 122 hereafter changes to the phase estimated by the change estimation unit 120 is presented in a manner allowing the user to grasp (view) the change. In the example shown in FIG. 3, the ordinate axis represents the phase (category and class), and the abscissa axis represents the elapsed time. The size of a circle represents the number of analyzed documents. The type of color or density may represent the magnitude of likelihood. In the case where a circle is drawn by broken lines, the circle represents a predicted (estimated) result, the size of the circle represents the number of predicted documents, and the color may represent the reliability of prediction. The presentation unit 130 may display the multiple documents extracted from the document information on the screen.

### (Classification Symbol Accepting and Assigning Unit 131)

The classification symbol accepting and assigning unit 131 accepts the classification symbol assigned by the user on the basis of the relevance to a litigation, and assigns the classification symbol to the documents that have been assigned no classification symbol and extracted from the document information.

### (Document Analyzer 118)

The document analyzer 118 analyzes the document assigned the classification symbol by the classification symbol accepting and assigning unit 131. The document analyzer 118 may analyze not only the documents for which the classification symbols have been accepted from the user and to which the classification symbols have been assigned on the basis of the relevance to the litigation, but also the documents automatically assigned the classification symbols by the first automatic classifier 201 and the second automatic classifier 301 on the basis of the keyword, related term and score, and integrate the documents for which the classification symbols have been accepted from the user and to which the classification symbols have been assigned, with the document automatically assigned the classification symbol to obtain an integrated analysis result. In this case, the third automatic classifier 401 can automatically assign the classification symbol on the basis of the integral analysis result.

Procedures of classification and investigation work are various procedures including: automatic classification through word search; acceptance of classification and investigation by the user; automatic classification and investigation using the score; automatic classification and investigation where a learning process intervenes; and automatic classification and investigation where quality assurance intervenes. With an advancement history that represents the order and combination of the various types of classification and investigation work, the multiple documents assigned the classification symbols are analyzed by the document analyzer 118, and the report creator 701, described below, may report the analyzed result.

### (Third Automatic Classifier 401)

The third automatic classifier 401 automatically assigns the classification symbol to the multiple documents extracted from the document information, on the basis of the result by the document analyzer 118 analyzing the documents assigned the classification symbol by the classification symbol accepting and assigning unit 131.

### (Tendency Information Generator 124)

The tendency information generator 124 generates tendency information that represents the degree of similarity to the document assigned the classification symbol of each document on the basis of the types of words, the number of appearances, and the evaluated values of the words, for analysis by the document analyzer 118.

### (Quality Inspector 501)

The quality inspector 501 compares the classification symbol accepted by the classification symbol accepting and assigning unit 131 with the classification symbol assigned according to the tendency information in the document analyzer 118, and verifies the appropriateness of the classification symbol accepted by the classification symbol accepting and assigning unit 131.

### (Learning Unit 601)

The learning unit 601 learns the weighting of each of keywords and related terms on the basis of the result of document classification process. The learning unit 601 learns the weighting of each keyword or related term on the basis of the first to fourth processing results (described later) according to the expression (2). The learning unit 601 may reflect the learned result in the keyword database 104, the related term database 105, or the score calculation database 106.

### (Report Creator 701)

The report creator 701 outputs an optimal investigation report on the basis of the result of the document classification process according to the investigation type of the litigation cases or fraud investigation. As described above, the litigation cases include, for example, antitrust, patent, The Foreign Corrupt Practices Act (FCPA), product liability (PL), etc. The fraud investigation may include, for example, information leakage, billing fraud, etc.

### (Attorney Review Accepting Unit 133)

The attorney review accepting unit 133 accepts a review by a chief attorney at law or a chief patent attorney in order to improve the qualities of classification and investigation and report and clarify the responsibilities of the classification and investigation and report.

### (Other Configuration)

The language determiner (not shown) determines the type of language of the extracted document.

The translator (not shown) automatically translates the extracted document upon acceptance of designation by the user or automatically. In this case, it is preferred that the delimited unit of the language in the language determiner be set smaller than one sentence so as to support multiple languages in multiple languages in one sentence. Any or both of predictive coding and character coding may be used to determine the language. Furthermore, a process of excluding the headers of HTML (Hyper Text Markup Language) and the like from the targets of translation may be performed.

The score change detector (not shown) detects the time-series change in score calculated by the score calculator 116.

The score change determiner (not shown) determines the degree of relevancy between the investigation case and the extracted document from the time-series change in score detected by the score change detector 120.

### DESCRIPTION OF TERMS

The term “classification symbol” is an identifier used to classify a document, and is an identifier that represents the degree of relevancy to a litigation to facilitate use of the document for the litigation. For example, the symbol may be assigned according to the type of evidence when document information is used as evidence in a litigation.

The term “document” is data including at least one word and is, for example, email, presentation materials, spreadsheet materials, discussion materials, a written contract, an organization chart, a business plan, etc.

The term “word” is a unit of a minimum character string having meaning. For example, the text “the document is data that includes at least one word” includes words “document”, “one”, “at least”, “word”, “includes”, “data”, and “is”.

The term “keyword” is a character string aggregate that has a certain meaning in a certain language. For example, keywords may be selected from text “classify a document” to obtain “text” and “classify”. In this embodiment, keywords such as “infringement”, “litigation” and “Patent publicaiton No. XX” are mainly selected. The “keyword” may be a morpheme.

The term “keyword correspondence information” is information that represents the correspondence relationship between a keyword and a specific classification symbol. For example, when the classification symbol “important” representing an important document in a litigation has a close relationship with a keyword “infringer”, the “keyword correspondence information” may be information that manages the classification symbol “important” and the keyword “infringer” in association with each other.

The term “related term” is a term having an evaluated value of at least a certain value among words having a high appearance frequency common to the documents assigned a predetermined classification symbol. Here, the appearance frequency may be a ratio of appearance of the related term to the total number of words appearing in one document.

The term “evaluated value” is a value that represents the amount of information exerted by each word in a certain document. The “evaluated value” may be calculated with reference to the amount of transmitted information. For example, when a predetermined trade name is assigned as a classification symbol, the “related term” may indicate the name of a technical field to which the product belongs, a country where the product is sold, a trade name similar to that of the product. More specifically, the “related terms” in the case of assigning, as a classification symbol, the trade name of an apparatus that performs an image coding process include “coding process”, “Japan” and “encoder”.

The term “related term correspondence information” is information that represents the correspondence relationship between a related term and a classification symbol. For example, when a classification symbol “product A” which is a trade name related to a litigation has a related term “image coding” which is a function of the product A, the “related term correspondence information” may be information where the classification symbol “product A” and the related term “image coding” are associated with each other and managed.

The term “score” is a value of qualitative evaluation of the strength of connection with a specific classification symbol in a certain document. In each embodiment of the present invention, for example, the score is calculated on the basis of words appearing in a document and the evaluated value of each word using the following expression (1).

[Expression 1]

Scr=Σᵢ₌₀^{N}i*(mᵢ*wgtᵢ²)/Σₜ₌₀^{N}i*wgtᵢ² (1)

Scr: Score of document
mᵢ: Appearance frequency of i-th keyword or related term
wgtᵢ²: Weight of i-th keyword or related term

The document analysis system 1 may extract a word that frequently appears in documents having a common classification symbol assigned by the user. The type of the extracted word included in each document, the evaluated value of each word, and tendency information on the number of appearances may be analyzed on a document-by-document basis, and a common classification symbol may be assigned to documents having the same tendency as the analyzed tendency information among documents where no classification symbol is accepted by the classification symbol accepting and assigning unit 131.

Here, the term “tendency information” is information that represents the degree of similarity to the document assigned the classification symbol of each document, and is represented by the degree of relevancy to the predetermined classification symbol based on the type of the word included in each document, the number of appearances, and the evaluated value of the word. For example, when each document is similar to the document assigned the predetermined classification symbol in degree of relevancy with this predetermined classification symbol, the two documents have the same tendency information. Documents including words having the same evaluated value with the same number of appearance even if the types of included words are different from each other may be regarded as documents having the same tendency.

### [Processes Executed by Document Analysis System 1]

FIG. 4 is a flowchart showing an example of processes (document analysis method according to the embodiment of the present invention) executed by the document analysis system 1. In the following description, parenthesized “-step” represents each step included in the document analysis method (a method of controlling the document analysis system 1).

The score calculator 116 calculates the score that represents the strength of connection of the document extracted from the document information to the classification symbol representing the degree of relevancy between the document information and the litigation or fraud investigation (S11, score calculation step). Next, the phase identifying section 122 identifies the phase by which the predetermined action to be a cause of the litigation or fraud investigation is classified along with the development of the predetermined action, on the basis of the score calculated by the score calculator 116 (S12, phase identification step). The change estimation unit 120 then estimates change in phase identified by the phase identifying section 122 on the basis of temporal transition of the phase (S13, change estimation step).

### [Details of Processes Executed by Document Analysis System 1]

The document analysis method according to the embodiment of the present invention is further described. FIG. 5 is a table showing the attributes of document case 1 and case 2 that are investigation targets in the document classification investigation method according to the present invention.

Each of the documents of cases 1 and 2 includes email or the like. The documents of cases 1 and 2 may be used as cases for optimizing the predictive coding (specifically among them, for example, sampling, file type classification, etc.). The weights and scores are calculated on the basis of information related to the “responsive” document. In the embodiment of the present invention, the email document of the case 1 is mainly described in English, and the email document of the case 2 are described in both of Japanese and English. The email documents in the cases 1 and 2 may be used as subsets.

In the embodiment of the present invention, a document as of Apr. 1, 2000 to Mar. 31, 2013 is used as the email document of the case 2.

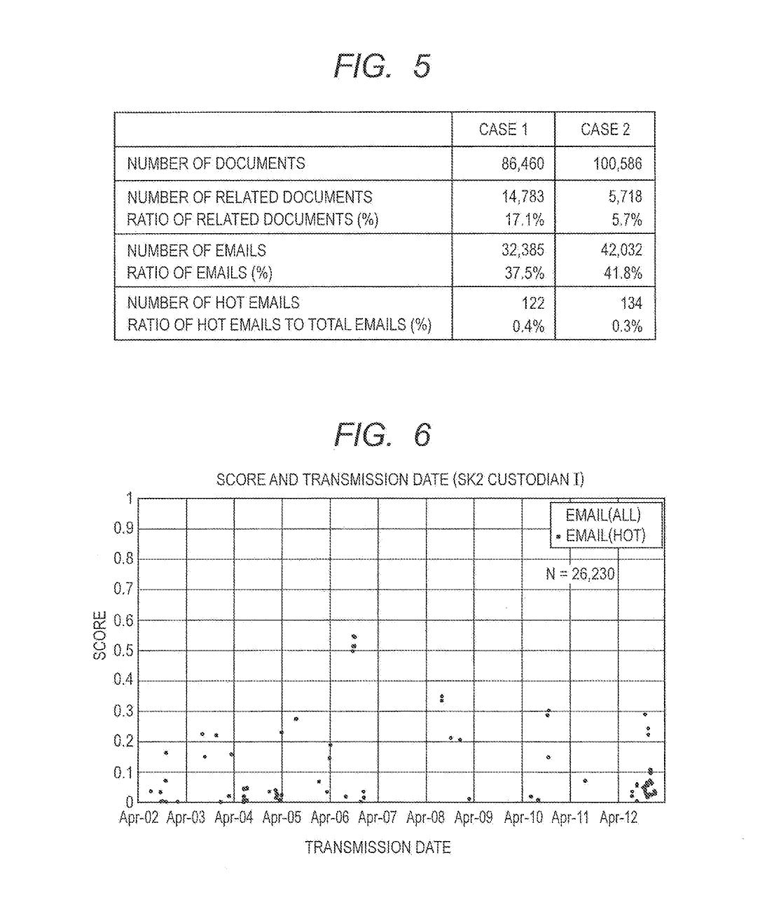

The document of the case 2 is used as an example, and score time-series analysis is described. First, referring to FIG. 6, an example of the relationship between the score and transmission date for an email document of the custodian 1 in relation to the case 2 is described.

Next, on the basis of the score, the moving average of scores is obtained, and characteristics and tendency obtained by analyzing the moving average are discussed. Here, the moving average (MA) is as follows.

$${SMA}_{M} = ( 1 / n ) {\sum }_{i = 0}^{n - 1} {Scr}_{M - i} \qquad [ Expression 2 ]$$

Here, SMAM is a simple moving average of {S_{crM}, S_{crM-1}, . . . , S_{crM-(n-1)}}. The S_{crM} is the score of an email document M.

The simple moving average SMA is calculated with respect to each document (email) M, on the basis of the score S_{crM} and the scores of pieces of email whose transmission dates are in a predetermined days or less before the transmission date of the email M {S_{crM-1}, . . . , S_{crM-(n-1)}}. The predetermined days may be appropriately defined. This embodiment defines seven days as a short term, 30 day as a mid-term, and 90 days as a long term.

Use of the simple moving average SMA allows the large fluctuation of the original score values to be smoothed.

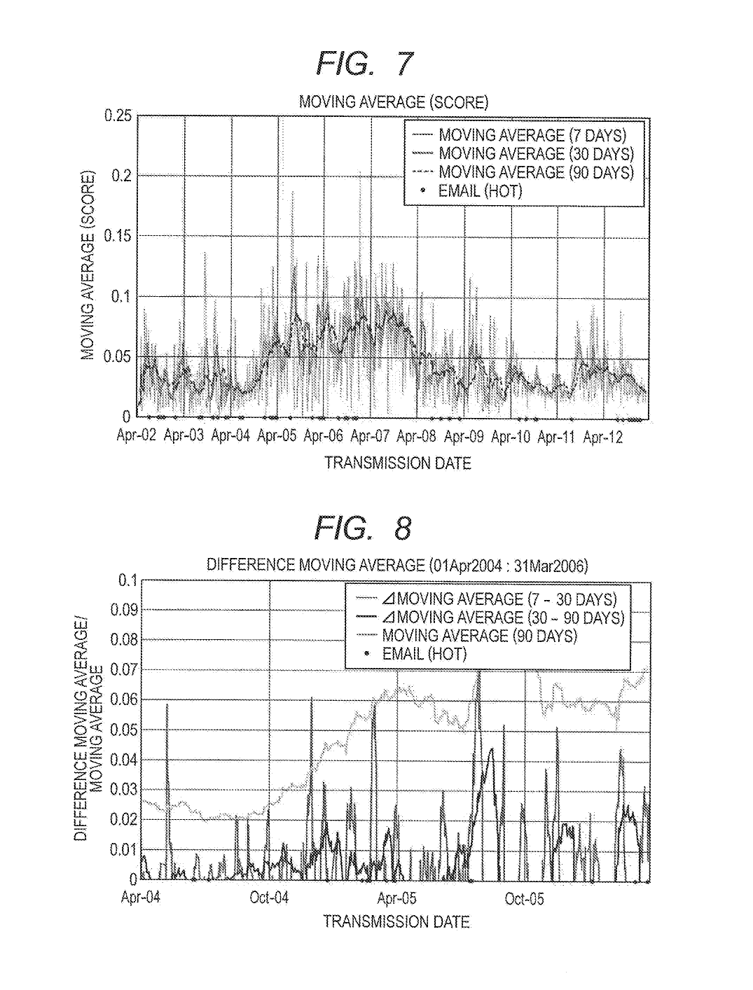

FIG. 7 is a graph showing the relationship between the score moving average and the transmission date. The predetermined days for the score moving average are any of the short term (seven days), mid-term (30 days) and long term (90 days). The moving average is calculated for each of the terms, and shown in FIG. 6. In FIG. 7, points with “HOT” only indicate the transmission date. Here, the short-term moving average includes a part where the value largely varies. On this part, the correlation with the “HOT” email is estimated.

Next, the calculation of the difference moving average is described. The difference of moving averages (DMA) is represented as follows.

ΔMA_{M12}=ΔMA_{M1}−ΔMA_{M2} [Expression 3]

### Here,

MA_{M1}: moving average 1 (short term: e.g., short-term (seven days))
MA_{M2}: moving average 2 (long term: e.g., mid-term (30 days))

The case where the value of the difference moving average ΔMA_{M12} is positive means that the value of the score is large in an immediately preceding term (i.e., the short term). It is assumed that a relatively large number of pieces of “HOT” email were transmitted in the short term, and changes to be investigated occurred. Consequently, according to the difference moving average, the characteristics and tendency of the email document that cannot be obtained through simple comparison of scores can be obtained. The change in characteristics and tendency described here is detected as an intersection of difference moving average curves, for example.

FIG. 8 is a graph showing the relationship between the difference of score moving average (DMA) and the transmission date from Apr. 1, 2004 to Mar. 31, 2006. The difference of moving averages (DMA) on the ordinate axis is normalized by the moving average.

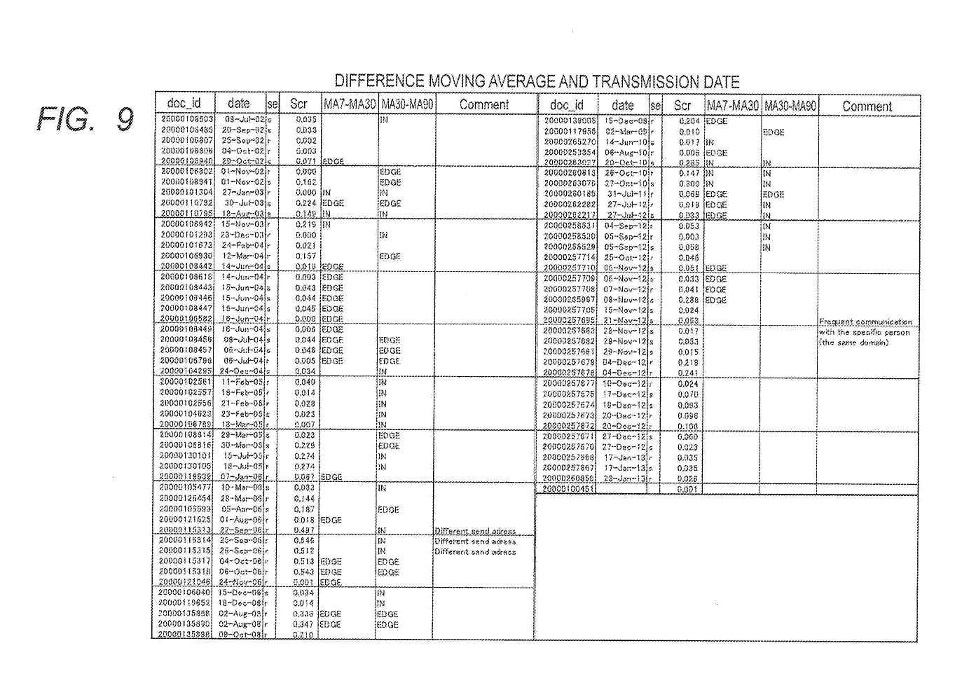

FIG. 9 is a table showing the relationship between the difference of score moving averages (DMA), transmission date, main (rising) edge (EDGE), and “IN”. The correlation between the “HOT” email and the difference of moving averages (DMA) is discussed. The degree of adjacency to the main (rising) edge of difference moving average (DMA) curve is also discussed.

The main (rising) edge (EDGE) is a site where the difference of moving average (DMA) changes from negative to positive, that is, the intersection between the difference of moving averages (DMA) and the horizontal axis.

The term IN means a region where the difference of moving averages (DMA) is positive.

As to an email document “HOT” of a custodian 1, presence or absence of a redundant piece of email having the same date and same score value is discussed. Deletion of the redundant piece of email reduces the number of “HOT” email documents from 98 pieces of email to 86 pieces of email. The number of pieces of email whose transmitters cannot be identified owing to the differences of addresses is four pieces of email, which is regarded as substantially, quantitatively absence.

Most of the scores of the pieces of “HOT” email of the custodian 1 have values which are not large. However, on the date when these were transmitted, “EDGE” or IN is detected.

The email documents transmitted on and after November 2012 do not have “EDGE” nor “IN”. Consequently, it is estimated that these pieces of email are related to frequent communication between specific persons in the same domain as that of the custodian 1.

Time-series data is described below. The moving average (MA) and the difference of moving averages (DMA) are excellent indicators for finding the basic characteristics and tendency of the time-series data.

The term “EDGE” of the difference of moving averages (DMA) may be an indicator that can detect the point of change in tendency of the score and indicates the presence of a piece of “HOT” email.

Analysis using the moving average (MA) or difference of moving averages (DMA) of score values has a possibility of detecting specific characteristics (e.g., possible “HOT”) in the time-series data. This enables selective dissemination of information (SDI) about a specific custodian or a specific group of custodians.

An example of procedures of executing time-series data analysis is described below.

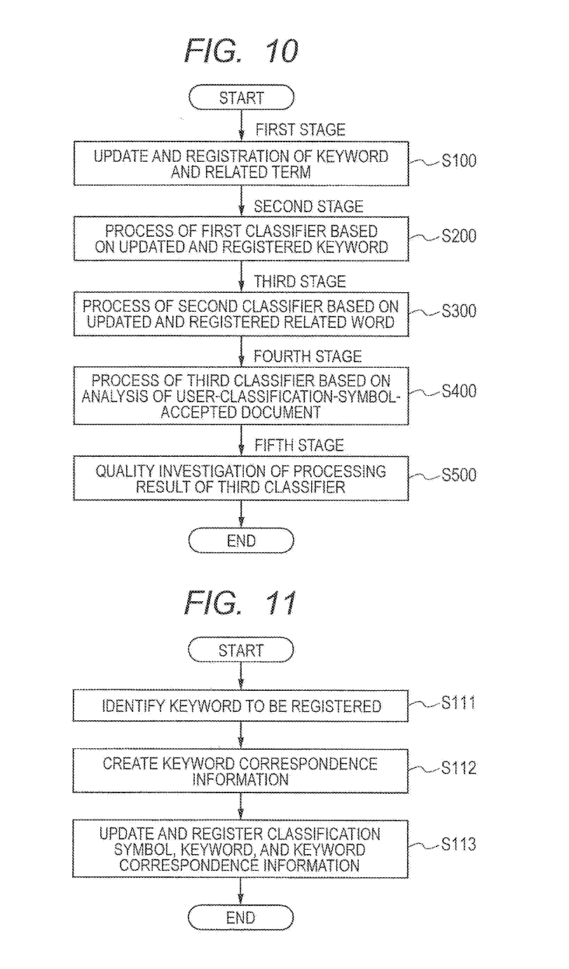

The time-series data analysis according to the embodiment of the present invention is performed in the document classification process in relation to the document classification, for example. An example of the document classification process is described below. The document classification process is performed according to a flowchart as shown in FIG. 10, through a registration process, a classification process and an inspection process, in first to fifth stages.

In the first stage, the keyword and the related term are preliminarily updated and registered using a result of a previous classification process (STEP100). At this time, the keyword and the related term are updated and registered together with the keyword correspondence information and the related term correspondence information which are correspondence information on the classification symbol and the keyword or the related term.

On the second stage, a first classification process is executed that extracts a document including the keyword updated and registered in the first stage from the entire document information, refers to the updated keyword correspondence information recorded in the first stage upon finding the document, and assigns the classification symbol corresponding to the keyword (STEP200).

On the third stage, the document including the related term updated and registered in the first stage is extracted from the document information assigned no classification symbol in the second stage, and the score of the document including the related term is calculated. A second classification process is executed that refers to the calculated score and the related term correspondence information updated and registered on the first stage and assigns the classification symbol (STEP300).

On the fourth stage, the classification symbol assigned by the user is accepted with respect to the document information where no classification symbol has been assigned until the third stage, and the classification symbol accepted from the user is assigned to the document information. Next, a third classification process is executed that analyzes the document information assigned the classification symbol accepted from the user, extracts the document assigned no classification symbol on the basis of the analysis result, and assigns the classification symbol to the extracted document. For example, a word frequently appearing in documents with the common classification symbol assigned by the user is extracted, the tendency information which is included in each document and is on the type of the extracted word, the evaluated value of each word, and the number of appearances may be analyzed on a document-by-document basis, and a common classification symbol is assigned to a document having the same tendency as the tendency information (STEP400).

On the fifth stage, the classification symbol to be assigned to the document to which the user has assigned the classification symbol is determined on the basis of the analyzed tendency information, the determined classification symbol is compared with the classification symbol assigned by the user, and the appropriateness of the classification process is verified. (STEP500) A learning process can be performed on the basis of the result of the document classification process as necessary.

Here, the tendency information used in the processes in the fourth and fifth stages is of each document, represents the degree of similarity to the document assigned the classification symbol, and is based on the type of the word included in each document, the number of appearances, and the evaluated value of the word. For example, when each document is similar to the document assigned the predetermined classification symbol in degree of relevancy with this predetermined classification symbol, the two documents have the same tendency information. Documents including words having the same evaluated value with the same number of appearance even if the types of included words are different from each other may be regarded as documents having the same tendency.

Detailed processing flows in each of the first to fifth stages are described as follows.

### <First Stage (STEP100)>

A detailed processing flow of the keyword database 104 on the first stage is described with reference to FIG. 11.

The keyword database 104 creates a table for management for each classification symbol in consideration of a result of classification of documents in previous litigations, and identifies a keyword corresponding to each classification symbol (STEP111). In the embodiment of the present invention, the identification may be made by analyzing the document assigned each classification symbol, using the number of appearances and evaluated value of each keyword in the document. Alternatively, a method of using the amount of transmitted information held by the keyword, or a method of manual selection by the user may be adopted.

In the embodiment of the present invention, for example, when keywords “infringement” and “patent attorney” are identified as keywords of a classification symbol “important”, keyword correspondence information indicating that the “infringement” and “patent attorney” are keywords having close relationship with the classification symbol “important” is created (STEP112). The identified keyword is registered in the keyword database 104. In this case, the identified keyword and the keyword correspondence information are associated with each other, and recorded in the management table of the classification symbol “important” of the keyword database 104 (STEP113).

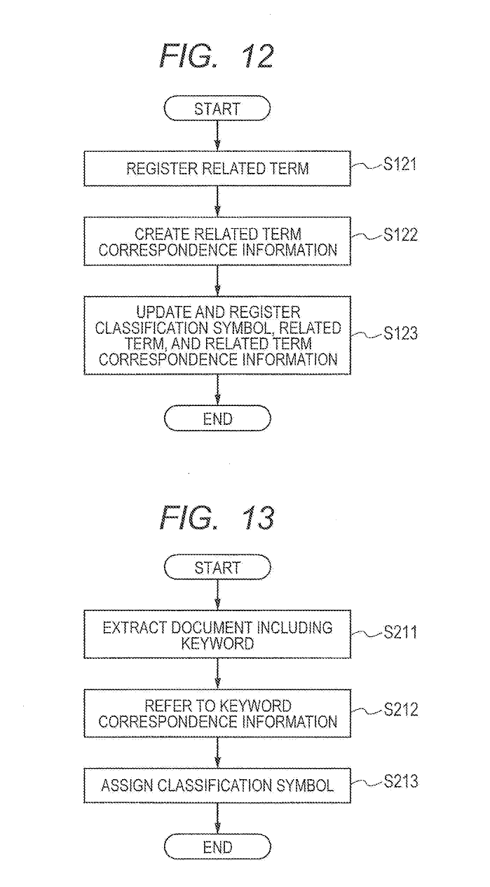

Next, a detailed processing flow of the related term database 105 is described with reference to FIG. 12. The related term database 105 creates a table for management for each classification symbol in consideration of a result of classification of documents in previous litigations, and registers a related term corresponding to each classification symbol (STEP121). In the embodiment of the present invention, for example, “coding process” and “product a” are registered as related terms of “product A”, and “decode” and “product b” are registered as related terms of “product B”.

The related term correspondence information indicating correspondence of the registered related terms to the classification symbols is created (STEP122), and recorded in each management table (STEP123). At this time, in the related term correspondence information, the evaluated value of each related term, and a threshold that serves as a score required to determine the classification symbol are recorded together.

Before actual classification work, the keyword and keyword correspondence information, and the related term and related term correspondence information are updated to the latest ones and registered (STEP113, STEP123).

### <Second Stage (STEP200)>

A detailed processing flow of the first automatic classifier 201 on the second stage is described with reference to FIG. 13. In the embodiment of the present invention, in the second stage, a process of assigning the classification symbol “important” to the document is performed by the first automatic classifier 201.

The first automatic classifier 201 extracts, from the document information, a document that includes “infringement” and “patent attorney” registered in the keyword database 104 in the first stage (STEP100), and extracts, from the document information, the document that includes keywords “infringement” and “patent attorney” registered in the keyword database 101 (STEP211). With respect to the extracted document, according to the keyword correspondence information, the management table that records the keyword is referred to (STEP212), and the classification symbol “important” is assigned (STEP213).

### <Third Stage (STEP300)>

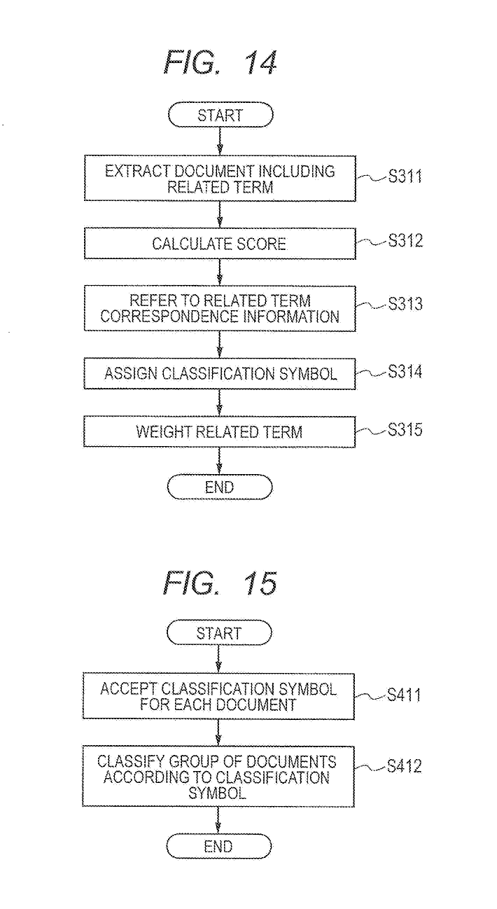

A detailed processing flow of the second automatic classifier 301 on the third stage is described with reference to FIG. 14.

In the embodiment of the present invention, the second automatic classifier 301 performs a process of assigning the classification symbols “product A” and “product B” to the document information having been assigned no classification symbol on the second stage (STEP200).

The second automatic classifier 301 extracts documents including the related terms “coding process”, “product a”, “decode” and “product b”, which have been recorded in the related term database 105 on the first stage, from the document information (STEP311). The scores of the extracted documents are calculated by the score calculator 116 using the expression (1) on the basis of the appearance frequencies and evaluated values of the recorded four related terms (STEP312). The score represents the degree of relevancies between each document and the classification symbols “product A” and “product B”.

When the score exceeds the threshold, the related term correspondence information is referred to (STEP313), and an appropriate classification symbol is assigned (STEP314).

For example, when the appearance frequencies of the related terms “coding process” and “product a” and the evaluated value of the related term “coding process” are high and the score representing the degree of relevancy to the classification symbol “product A” exceeds the threshold in a certain document, the document is assigned the classification symbol “product A”.

At this time, when the appearance frequency of the related term “product b” is also high and the score representing the degree of relevancy to the classification symbol “product B” exceeds the threshold, the document is assigned the classification symbol “product B” besides the classification symbol “product A”. On the contrary, when the appearance frequency of the related term “product b” is low and the score representing the degree of relevancy to the classification symbol “product B” does not exceed the threshold, the document is only assigned the classification symbol “product A”.

In the second automatic classifier 301, the evaluated value of the related term is recalculated according to the following expression (2) using the score calculated in STEP432 on the fourth stage, and the evaluated value is weighted (STEP315).

[Expression 4]

wgt_{i,L}=\sqrt{wgtᵢ₋₁²+γ_{L}wgt_{i,L}²−∂}=\sqrt{wgt_{i,L}²+Σₗ₌₁^{L}(γₗwft_{i,l}²−∂)} (2)
wgt_{i,0}: Weight of i-th selected keyword before learning (initial value)
wgt_{i,L}: Weight of i-th selected keyword after L times of learning
Y_{L}: Learning parameter in L-th learning
θ: Threshold of learning effect

For example, when a certain number of documents that have a significantly high appearance frequency of “decode” but have a score is as low as a certain value or less occur, the evaluated value of the related term “decode” is reduced and recorded in the related term correspondence information again.

### <Fourth Stage (STEP400)>

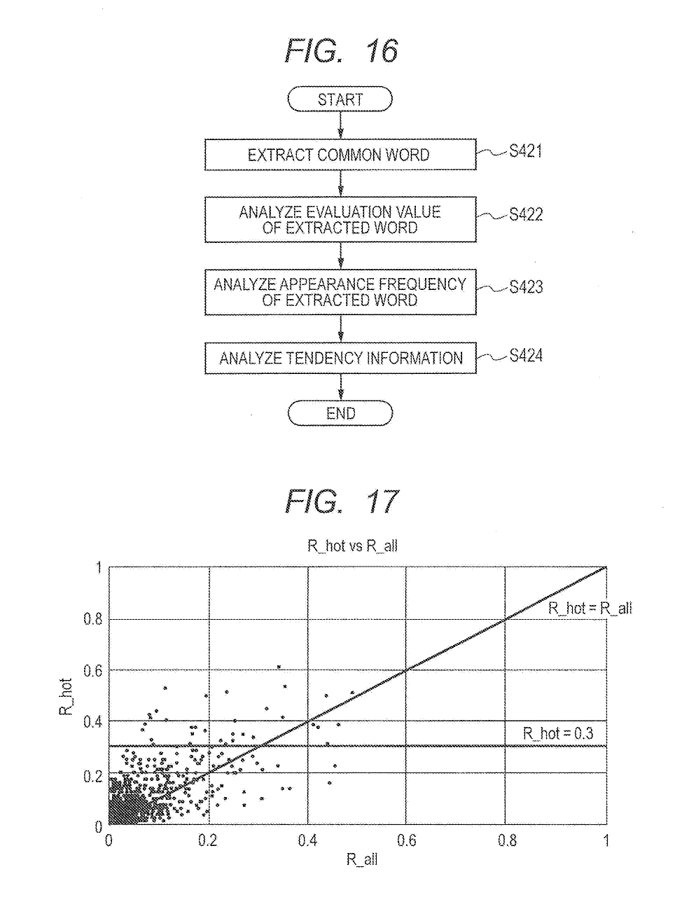

On the fourth stage, as shown in FIG. 15, assignment of the classification symbol from a reviewer to a certain ratio of pieces of document information extracted from the document information having being assigned no classification symbol until the processes of the third stage is accepted, and the accepted classification symbol is assigned to the document information. Next, as shown in FIG. 16, the document information assigned the classification symbol accepted from the reviewer is analyzed, the document information assigned no classification symbol is assigned the classification symbol on the basis of the analysis result. In the embodiment of the present invention, on the fourth stage, for example, a process of assigning the classification symbols “important”, “product A” and “product B” is executed. The fourth stage is further described as follows.

A detailed flow of the classification symbol accepting and assigning unit 131 on the fourth stage is described with reference to FIG. 15. First, the document extractor 112 randomly samples document from the document information that is to be a processing target on the fourth stage, and displays the document on the document display unit 130. In the embodiment of the present invention, documents that are 20% of document information to be processed are randomly extracted, and treated as classification targets to be classified by the reviewer. The sampling may be performed according to an extraction method that arranges the documents in an order of the creation date and time or name and selects 30% of documents from the top.

The user views a document display screen 11 that is displayed on the document display unit 130 and shown in FIG. 21, and selects the classification symbol to be assigned to each document. The classification symbol accepting and assigning unit 131 accepts the classification symbol selected by the user (STEP411), and performs classification on the basis of the assigned classification symbol (STEP412).

Next, a detailed flow of the document analyzer 118 is described with reference to FIG. 16. The document analyzer 118 extracts a word frequently appearing in common to the documents classified by the classification symbol accepting and assigning unit 131, according to each classification symbol (STEP421). The evaluated value of the common word extracted is analyzed according to the expression (2) (STEP422), and the appearance frequency of the common word in the document is analyzed (STEP423).

Furthermore, in consideration of the results analyzed in STEP 422 and STEP 423, the tendency information on the document assigned the classification symbol “important” is analyzed (STEP424).

FIG. 17 is a graph of results of analysis of words frequently appearing in common to the documents assigned the classification symbol “important” in STEP 424.

In FIG. 17, the ordinate axis R_hot represents the ratio of documents that includes the word selected as a word associated with the classification symbol “important” and is assigned the classification symbol “important” among all the documents assigned the classification symbol “important”. The abscissa axis represents the ratio of documents that includes the word extracted in STEP 421 by the classification symbol accepting and assigning unit 131 among all the documents to which the user has applied the classification process.

In the embodiment of the present invention, the classification symbol accepting and assigning unit 131 extracts words plotted higher than a straight line R_hot=R_all as the common words with the classification symbol “important”.

The processes in STEP421 to STEP424 are executed also to documents assigned the classification symbols “product A” and “product B”, and the tendency information on the documents is analyzed.

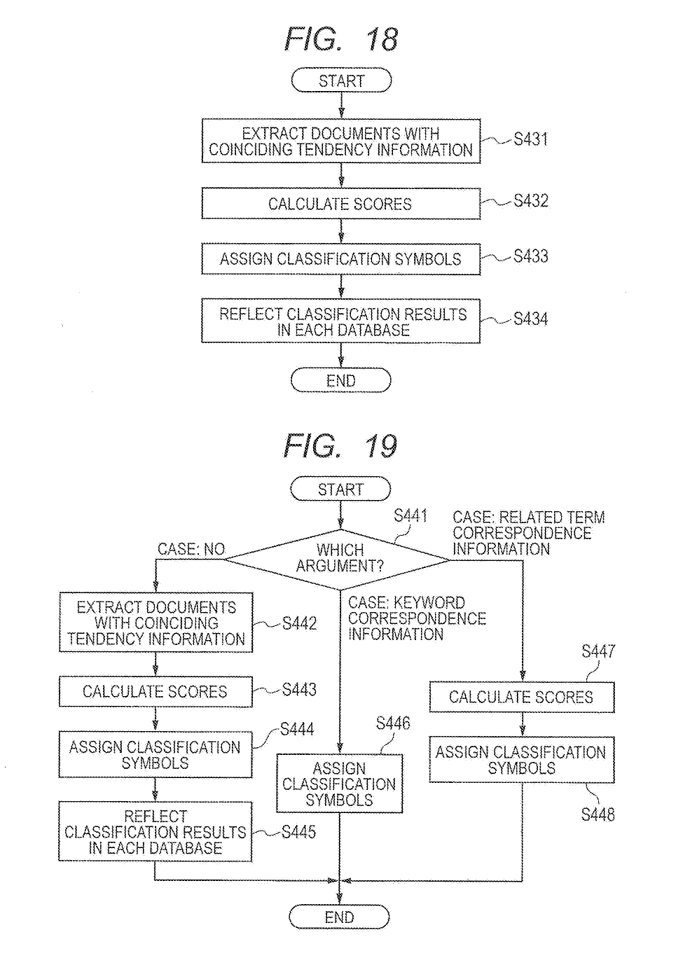

Next, a detailed processing flow of the third automatic classifier 401 is described with reference to FIG. 18. The third automatic classifier 401 applies a process to documents where assignment of the classification symbol has not been accepted by the classification symbol accepting and assigning unit 131 in STEP411 among the processing target document information on the fourth stage. The third automatic classifier 401 extracts documents having the same tendency information as the documents that have been analyzed in STEP424 and assigned the classification symbols “important”, “product A” and “product B” (STEP431), and calculates the scores of the extracted documents on the basis of the tendency information using the expression (1) (STEP432). The documents extracted in STEP431 are assigned appropriate classification symbols on the basis of the tendency information (STEP433).

The third automatic classifier 401 reflects the classification result in each database using the scores calculated in STEP432 (STEP434). More specifically, a process may be performed that reduces the evaluated values of the keyword and the related term included in the document with a low score while increasing the evaluated values of the keyword and the related term included in the document with a high score.

Furthermore, an example of a detailed processing flow of the third automatic classifier 401 is described with reference to FIG. 19. The third automatic classifier 401 may apply a classification process to documents where assignment of the classification symbol has not been accepted by the classification symbol accepting and assigning unit 131 in STEP411 in the processing target document information on the fourth stage. When no argument is provided (STEP441: NO), the third automatic classifier 401 extracts documents having the same tendency information as the documents that have been analyzed in STEP424 and assigned the classification symbol “important” (STEP442), and calculates the scores of the extracted documents on the basis of the tendency information using the expression (1) (STEP443). The documents extracted in STEP442 are assigned appropriate classification symbols on the basis of the tendency information (STEP444).

The third automatic classifier 401 reflects the classification result in each database using the scores calculated in STEP443 (STEP445). More specifically, a process is performed that reduces the evaluated values of the keyword and the related term included in the document with a low score while increasing the evaluated values of the keyword and the related term included in the document with a high score.

As described above, score calculation is performed by both the second automatic classifier 301 and the third automatic classifier 401. When the number of score calculations is high, data items for score calculation may be collectively stored in the score calculation database 106.

### <Fifth Stage (STEP500)>

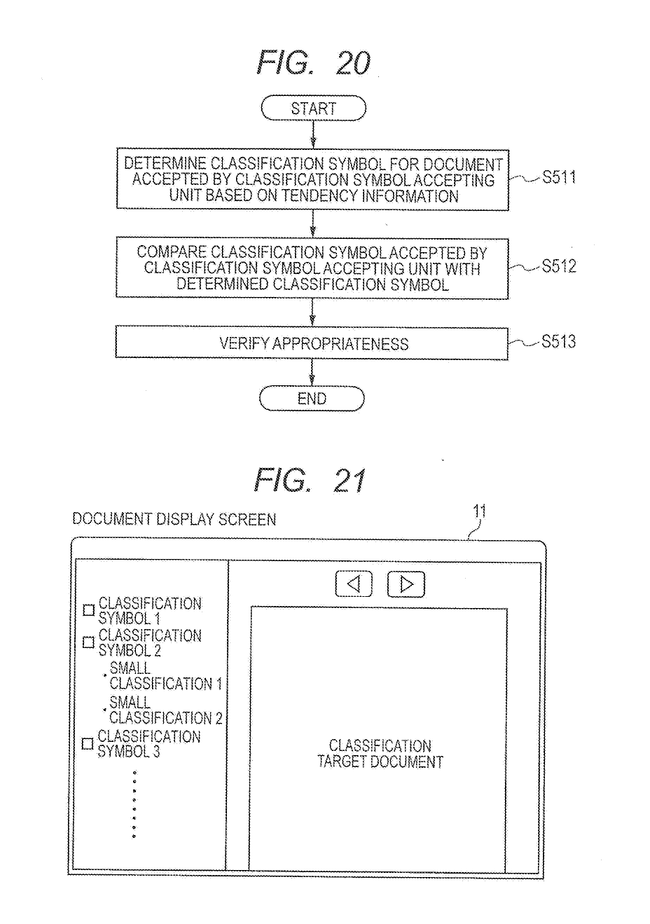

A detailed processing flow of the quality inspector 501 on the fifth stage is described with reference to FIG. 20. In the quality inspector 501, the classification symbol accepting and assigning unit 131 determines a classification symbol to be assigned to the document accepted in STEP411, on the basis of the tendency information analyzed by the document analyzer 118 in STEP424 (STEP511).

The classification symbol accepted by the classification symbol accepting and assigning unit 131 is compared with the classification symbol determined in STEP511 (STEP512), and the appropriateness of the classification symbol accepted in STEP411 is verified (STEP513).

### (Advantageous Effects Exerted by Document Analysis System 1)

The document analysis system 1 can predict possible events in the future by analyzing existing data. Consequently, the document analysis system 1 can take measures that prevent unfavorable situations, such as development to a litigation, for example.

### <Note>

The control blocks of the document analysis system 1 may be implemented by logic circuits (hardware) formed on an integrated circuit (IC chip) and the like or software through use of CPU (Central Processing Unit). In the latter case, the document analysis system 1 includes a CPU that executes instructions of a program (control program) that are software implementing each function, ROM (Read Only Memory) or a storage device (which is called a “recording medium”) where the program and various data items are recorded in a manner readable by a computer (or CPU), and RAM (Random Access Memory) where the program is deployed. The computer (or CPU) reads the program from the recording medium and executes the program, thereby achieving the object of the present invention. The recording medium may be a “non-transitory, tangible medium”, for example, a tape, a disk, a card, a semiconductor memory, a programmable logic circuit, etc. The program may be supplied to the computer via any transmission medium (communication network, broadcast waves, etc.) that can transmit the program. The present invention can be achieved in a form of a data signal embedded in carrier waves implemented through electronic transmission of the program.

The present invention is not limited to each of the embodiments, and can be variously changed within a range represented by the claims. Embodiments obtained by appropriately combining pieces of technical means disclosed in different embodiments are also included in the technical scope of the present invention. Furthermore, combination of pieces of technical means disclosed in the embodiments can form new technical characteristics.

A document classification and investigation system that obtains digital information recorded in multiple computers or servers, analyzes document information including multiple documents included in the obtained digital information, and investigates a degree of relevancy between an investigation case and the document through assigning the document a classification symbol representing a degree of relevancy to the investigation case so as to facilitate use for the investigation case, includes: a score calculator that extracts a document from the document information, and calculates a score that represents a strength of connection of the extracted document to the classification symbol in a time-series manner; a score change detector that detects time-series change in score from the calculated score; and a score change determiner that investigates and determines the relevancy between the investigation case and the document from the detected time-series change in the score.

In the document classification and investigation system, the score change detector includes: a score moving average calculator that calculates a moving average of scores; and a score difference moving average calculator that calculates a difference moving average of scores from a short-term moving average and long-term moving average of the scores.

In the document classification and investigation system, the score change determiner investigates and determines the degree of relevancy between the investigation case and the extracted document, based on a point where a sign of the difference of different moving averages changes, or a region where the difference of different moving averages is positive.

A document classification and investigation method that obtains digital information recorded in multiple computers or servers, analyzes document information including multiple documents included in the obtained digital information, and investigates a degree of relevancy between an investigation case and the document through assigning the document a classification symbol representing a degree of relevancy to the investigation case so as to facilitate use for the investigation case, causes a computer to: extract a document from the document information, and calculate a score that represents a strength of connection of the extracted document to the classification symbol in a time-series manner; detect time-series change in score from the calculated score; and investigate the relevancy between the investigation case and the extracted document from the detected time-series change in the score.

The document classification and investigation method calculates a short-term moving average and a long-term moving average of scores by calculating a moving average of scores, and detects time-series change in score by calculating a difference moving average of scores from the short-term moving average and long-term moving average of scores.

The document classification and investigation method investigates and determines the degree of relevancy between the investigation case and the extracted document, based on a point where a sign of the difference of different moving averages changes, or a region where the difference of different moving averages is positive.

A document classification and investigation program that obtains digital information recorded in multiple computers or servers, analyzes document information including multiple documents included in the obtained digital information, and investigates a degree of relevancy between an investigation case and the document through assigning the document a classification symbol representing a degree of relevancy to the investigation case so as to facilitate use for the investigation case, causes a computer to achieve: a function of extracting a document from the document information, and calculating a score that represents a strength of connection of the extracted document to the classification symbol in a time-series manner; a function of detecting time-series change in score from the calculated score; and a function of investigating the relevancy between the investigation case and the extracted document from the detected time-series change in the score.

### REFERENCE SIGNS LIST

1 Document analysis system
201 First automatic classifier
301 Second automatic classifier
401 Third automatic classifier
501 Quality inspector
601 Learning unit
701 Report creator
100 Data storage
101 Digital information storing area
103 Investigation basis database
104 Keyword database
105 Related term database
106 Score calculation database
107 Report creation database
109 Database manager
112 Document extractor
114 Word searcher
116 Score calculator
118 Document analyzer
120 Change estimation unit
122 Phase identifying section
124 Tendency information generator
130 Presentation unit
131 Classification symbol accepting and assigning unit
133 Attorney review accepting unit
140 Score moving average calculator
142 Score difference moving average calculator
11 Document display screen

1. A document analysis system that obtains information recorded in a predetermined computer or server, and analyzes document information including multiple documents included in the obtained information, comprising:
a score calculator that calculates a score that represents a strength of connection of a document extracted from the document information to a classification symbol representing a degree of relevancy between the document information and a litigation or fraud investigation;
a phase identifying section that identifies a phase by which a predetermined action to be a cause of the litigation or fraud investigation is classified along with development of the predetermined action, based on the score calculated by the score calculator; and
a change estimation unit that estimates change in the phase identified by the phase identifying section, based on temporal transition of the phase.

2. The document analysis system according to claim 1, further comprising
a score moving average calculator that calculates a moving average of the scores calculated by the score calculator,
wherein the change estimation unit estimates change in the phase by calculating a correlation between the moving average calculated by the score moving average calculator and a predetermined pattern.

3. The document analysis system according to claim 1, further comprising
a presentation unit that presents the change in the phase estimated by the change estimation unit in a manner allowing a user to grasp the change.

4-6. (canceled)

7. The document analysis system according to claim 2, further comprising:
a presentation unit that presents the change in the phase estimated by the change estimation unit in a manner allowing a user to grasp the change.

8. The document analysis system according to claim 1, further comprising:
a classification symbol assigner that assigns the classification symbol to each of the documents using a keyword and/or text included in the document information.

9. The document analysis system according to claim 2, further comprising:
a classification symbol assigner that assigns the classification symbol to each of the documents using a keyword and/or text included in the document information.

10. The document analysis system according to claim 3, further comprising:
a classification symbol assigner that assigns the classification symbol to each of the documents using a keyword and/or text included in the document information.

11. The document analysis system according to claim 7, further comprising:
a classification symbol assigner that assigns the classification symbol to each of the documents using a keyword and/or text included in the document information.

12. A document analysis method that obtains information recorded in a predetermined computer or server, and analyzes document information including multiple documents included in the obtained information, comprising:
a score calculation step of calculating a score that represents a strength of connection of a document extracted from the document information to a classification symbol representing a degree of relevancy between the document information and a litigation or fraud investigation;
a phase identification step of identifying a phase by which a predetermined action to be a cause of the litigation or fraud investigation is classified along with development of the predetermined action, based on the score calculated in the score calculation step; and
a change estimation step of estimating change in the phase identified in the phase identification step, based on temporal transition of the phase.

13. A document analysis program that obtains information recorded in a predetermined computer or server, and analyzes document information including multiple documents included in the obtained information, causing a computer to achieve:
a score calculation function of calculating a score that represents a strength of connection of a document extracted from the document information to a classification symbol representing a degree of relevancy between the document information and a litigation or fraud investigation;
a phase identifying function of identifying a phase by which a predetermined action to be a cause of the litigation or fraud investigation is classified along with development of the predetermined action, based on the score calculated by the score calculation function; and
a change estimation function of estimating change in the phase identified by the phase identifying function, based on temporal transition of the phase.
